(19) United States
(12) Patent Application Publication
(10) Pub. No.: US 2008/0252559 A1
(43) Pub. Date: Oct. 16, 2008

(54) Plasma display and a driving method for the display

(76) Inventors: Woo-Joon Chung, Suwon-si (KR); Jin-Sung Kim, Suwon-si (KR); Hyuk-Jae Lee, Seoul (KR)

Correspondence Address: ROBERT E. BUSHNELL, 1522 K STREET NW, SUITE 300, WASHINGTON, DC, 20005-1202, US

(21) Appl. No.: 12/078,472

(22) Filed: Mar. 31, 2008

(30) Foreign Application Priority Data
Apr. 12, 2007 (KR) 10-2007-0036007

(51) Int. Cl. G09G 3/28

(52) U.S. Cl. 345/60; 345/690

(57) ABSTRACT

A method for driving a plasma display in which a light emitting state of a plurality of discharge cells of a row electrode is determined in an n^{th} subfield, a line load ratio of the row electrode in the n^{th} subfield is calculated based on the light emitting state, and an output estimation weight of the n^{th} subfield is calculated. Gray levels of the subfields are updated by using the calculated output estimation weight of the n^{th} subfield. Subsequently, the light emitting state of the discharge cells of the row electrode is determined in an (n−1)^{th} subfield by using an initial set weight of the (n−1)^{th} subfield to express the updated gray level, and the line load ratio of the row electrode in the (n−1)^{th} subfield is calculated to determine the output of the (n−1)^{th} subfield. The gray levels for the (n−2)^{th} subfields are updated using the updated output estimation weight.

### CLAIM OF PRIORITY

This application makes reference to, incorporates the same herein, and claims all benefits accruing under 35 U.S.C. §119 from an application for PLASAL4 DISPLAY AND DRIVING METHOD THEREOF earlier filed in the Korean Intellectual Property Office on 12 Apr. 2007 and there duly assigned Serial No. 10-2007-0036007.

### BACKGROUND OF THE INVENTION

1. Field of the Invention

The present invention relates to a plasma display and a driving method thereof.

2. Description of the Related Art

A plasma display is a flat panel display that uses plasma generated by gas discharge to display characters or images. In general, one frame of the plasma display is divided into a plurality of subfields so as to drive the plasma display. Turn-on/turn-off cells (i.e., cells to be turned on or off) are selected during an address period of each subfield, and a sustain discharge operation is performed on the turn-on cells so as to display an image during a sustain period. Grayscales are expressed by a combination of weights of the subfields that are used to perform a display operation.

In a display panel of the plasma display, a plurality of row electrodes and a plurality of column electrodes are formed, and discharge cells are formed at each area where the row electrodes cross the column electrodes. Accordingly, currents flowing to the row electrodes vary according to the number of the turn-on cells thereof, and a voltage drop varies according to the currents. Since the voltage drop is reduced as the number of turn-on cells of the row electrode is reduced, luminance in one discharge cell is increased when the voltage drop is reduced. That is, since the luminance expressed by one subfield varies according to the number of turn-on cells of the row electrodes, a luminance deviation at the row electrode may occur for the same gray scale.

The above information disclosed in this Background section is only for enhancement of understanding of the background of the invention and therefore it may contain information ii that does not form the prior art that is already known in this country to a person of ordinary skill in the art.

### SUMMARY OF THE INVENTION

The present invention has been made in an effort to provide a plasma display for preventing luminance deviation according to a line road ratio, and a driving method thereof

In an exemplary method for driving a plasma display including a row electrode, a plurality of column electrodes, and a plurality of discharge cells defined by the row electrode and the plurality of column electrodes, one frame is divided into a plurality of subfields respectively having initial set weights, the initial set weight is used to determine a light emitting state of the plurality of discharge cells of the row electrode by a gray level of image data input during one frame in a first subfield among the plurality of subfields, a line load ratio of the row electrode is calculated based on the light emitting state of the plurality of discharge cells of the row electrode in the first subfield, an output estimation weight of the first subfield is calculated based on the line load ratio of the row electrode in the first subfield, the gray level is updated according to the output estimation weight of the first subfield, the initial set weight is used to determine the light emitting state of the plurality of discharge cells of the row electrode by the updated gray level in a second subfield among the plurality of subfields, the line load ratio of the row electrode is calculated based on the light emitting state of the plurality of discharge cells of the row electrode in the second subfield, the output estimation weight of the second subfield is calculated based on the line load ratio of the row electrode in the second subfield, and the updated gray level is updated according to the output estimation weight of the second subfield.

In another exemplary method for driving a plasma display including a row electrode, a plurality of column electrodes, and a plurality of discharge cells defined by the row electrode and the plurality of column electrodes, one frame is divided into a plurality of subfields respectively having initial set weights, n is established to be i (here, n is a positive integer, and i≦n), a light emitting state of the plurality of discharge cells of the row electrode in an n^{th} subfield is determined based on a gray level of input image data and the initial set weight, a line load ratio of the row electrode is calculated based on the determined light emitting state in the n^{th} subfield, an output estimation weight of the n^{th} subfield is calculated based on the line load ratio of the row electrode, a gray level is updated based on the output estimation weight of the n^{th} subfield, n is established to be j that is different from i, and the determining of the light emitting state, the calculating of the line load ratio, the calculating of the output estimation weight, and updating of the gray level are repeatedly performed.

An exemplary plasma display according to an embodiment of the present invention includes a row electrode, a controller, and a driver. The plurality of discharge cells are formed in the row electrode. The controller divides one frame into a plurality of subfields respectively having initial set weights, updates a gray level of image data according to an output estimation weight of an i^{th} subfield of the plurality of subfields, and determines a light emitting state of the plurality of discharge cells according to the updated gray level by using the initial set weight of the plurality of subfields in an (i−1)^{th} subfield. The driver discharges the plurality of discharge cells according to the light emitting state of the plurality of discharge cells in the plurality of subfields. The light emitting state of the plurality of discharge cells in an (i+1)^{th} subfield is determined based on the gray level, and the output estimation weight of the i^{th} subfield is determined based on the initial set weight of the plurality of subfields and the determined light emitting state in the (i+1)^{th} subfield.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of a plasma display according to an exemplary embodiment of the present invention.

FIG. 2 is a diagram representing a subfield arrangement according to a first exemplary embodiment of the present invention.

FIG. 3 is a diagram representing luminance characteristics according to a line load ratio.

FIG. 4 is a diagram representing a luminance ratio according the line load ratio

FIG. 5 is a schematic block diagram of a controller according to the exemplary embodiment of the present invention.

FIG. 6 is a flowchart representing a method for compensating the luminance in the controller according to the exemplary embodiment of the present invention.

FIG. 7 is a diagram representing an algorithm of the method shown in FIG. 6.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

Throughout this specification and the claims which follow, unless explicitly described to the contrary, the word “comprise”, and variations such as “comprises” or “comprising” will be understood to imply the inclusion of stated elements but not the exclusion of any other elements.

A plasma display and a driving method thereof according to an exemplary embodiment of the present invention will now be described with reference to the figures.

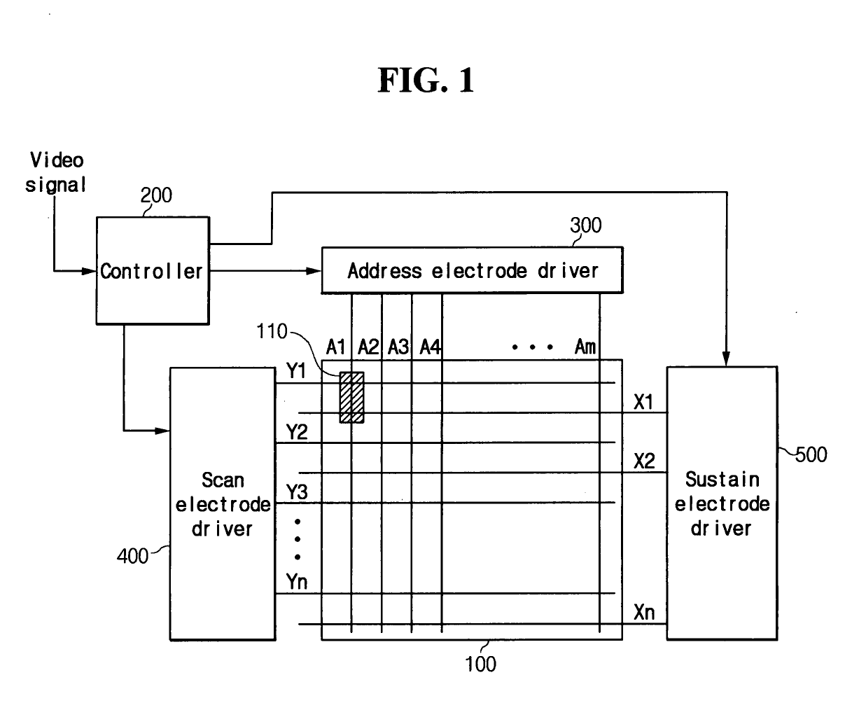

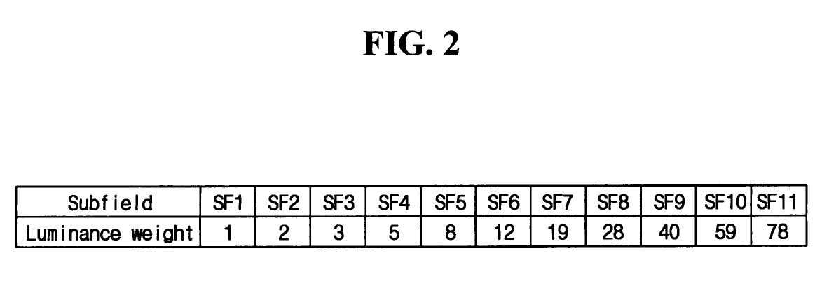

FIG. 1 is a diagram of a plasma display according to the exemplary embodiment of the present invention, and FIG. 2 is a diagram representing a subfield arrangement according to a first exemplary embodiment of the present invention.

As shown in FIG. 1, the plasma display according to the first exemplary embodiment of the present invention includes a plasma display panel (PDP) 100, a controller 200, an address electrode driver 300, a sustain electrode driver 400, and a scan electrode driver 500.

The PDP 100 includes a plurality of address electrodes (hereinafter referred to as A electrodes) A1 to Am extending in a column direction, and a plurality of sustain and scan electrodes (hereinafter referred to as X and Y electrodes) X1 to Xn and Y1 to Yn in pairs extending in a row direction. In general, the X electrodes X1 to Xn respectively correspond to the Y electrodes Y1 to Yn, and neighboring X and Y electrodes form a row electrode. The Y and X electrodes Y1 to Yn and X1 to Xn are arranged perpendicular to the A electrodes A1 to Am, and a discharge space formed at an area where the address electrodes A1 to Am cross the sustain and scan electrodes X1 to Xn and Y1 to Yn forms a discharge cell 110. Since phosphor layers of red, green, and blue are alternately formed in a plurality of A electrodes A1 to Am in a row direction, it is assumed that discharge cells of red, green, and blue are alternately arranged in the PDP 100 in a row direction.

The controller 200 divides one frame into a plurality of subfields having respective luminance weights, and each subfield includes an address period and a sustain period. In addition, the controller 200 converts a plurality of video data for the plurality of discharge cells 110 into subfield data indicating respective light emitting/non-light emitting states in the plurality of subfields. Further, according to the subfield data, the controller applies driving control signals to the address, scan, and sustain electrode drivers 300, 400, and 500. In FIG. 2, one frame includes 11 subfields SF1 to SF11 respectively having weights of 1, 2, 3, 5, 8, 12, 19, 28, 40, 59, and 78, and grayscales from 0 to 255 may be expressed. From the weights of each subfield, image data of 120 grayscale may be converted to subfield data of “10011011010”. Here, “10011011010” respectively corresponds to the plurality of subfields SF1 to SF11, “1” indicates that the discharge cell is light-emitted in a corresponding subfield, and “0” indicates that the discharge cell is not light-emitted in the subfield.

The address electrode driver 300 applies a driving voltage to the plurality of A electrodes A1 to Am according to the driving control signal from the controller 200.

The scan electrode driver 400 applies the driving voltage to the plurality of Y electrodes Y1 to Yn according to the driving control signal from the controller 200.

The sustain electrode driver 500 applies the driving voltage to the plurality of X electrodes X1 to Xn according to the driving control signal from the controller 200.

In further detail, the address, scan, and sustain electrode drivers 300, 400, and 500 select a light emitting cell and a non-light emitting cell among the plurality of discharge cells in the corresponding subfield during the address period of each subfield. During the sustain period of each subfield, the address, scan, and sustain electrode drivers 300, 400, and/or 500 apply a sustain pulse to the plurality of Y electrodes Y1 to Yn and/or plurality of X electrodes X1 to Xn a predetermined number of times corresponding to the weight value of the corresponding subfield so as to repeatedly perform sustain discharge for the light emitting cell.

Hereinafter, a ratio of turned on cells in each row electrode line will be defined as a “line load ratio”, and a ratio of turned on cells in the entire screen of the PDP 100 will be defined as a “screen load ratio”.

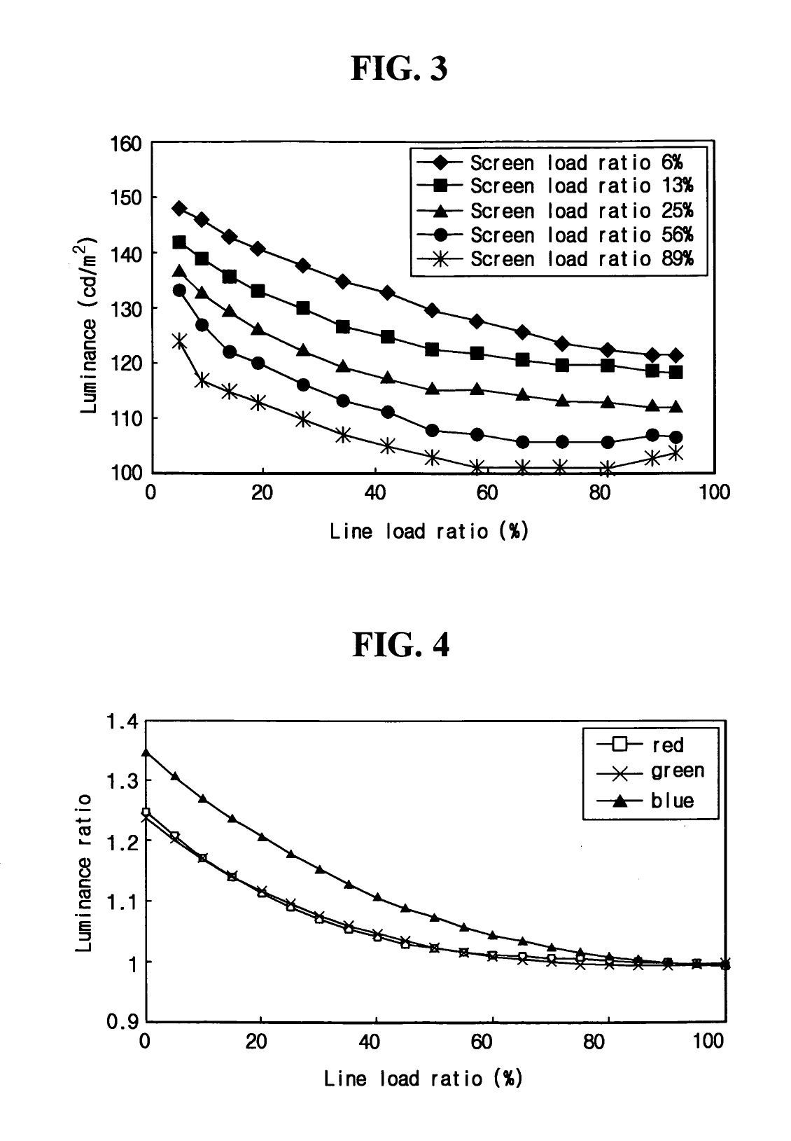

FIG. 3 is a diagram representing luminance characteristics according to the line load ratio, and FIG. 4 is a diagram representing a luminance ratio according the line load ratio. In FIG. 3, the horizontal axis represents line load ratio, and the vertical axis represents luminance. In addition, in FIG. 3, while the line load ratio in the row electrode line including a cell to be measured is fixed, turned on cells in other row electrode lines are adjusted to change the screen load ratio and measure the luminance. In FIG. 4, the horizontal axis represents the line load ratio, and the vertical axis represents a relative luminance while assuming that the luminance is 100 when the line load ratio is 100%. In addition, “red”, “green”, and “blue” respectively indicate cases that the red, green, and blue discharge cells are respectively light-emitted.

As shown in FIG. 3, it can be understood that the luminance varies according to the screen load ratio, and it varies according to the line load ratio. Particularly, as shown in FIG. 4, the luminance increases as the line load ratio decreases, which differs in the respective red, green, and blue discharge cells. As described, when the luminance varies according to the line load ratio, an error occurs in an output grayscale of the PDP 100. A reason why an error occurs in an output grayscale when the luminance varies according to the line load ratio will now be described. Firstly, a luminance variation ratio of each discharge cell may be given as Equation 1 to Equation 3. Equation 1 to Equation 3 are regression equations obtained from Equation 4.

$$\begin{matrix}{LR}_{r} ( L ) = \frac{1}{100} ( \begin{matrix}124.741 - 0.86185216 L + \\ 0.01046528 {L}^{2} - 0.00004362 {L}^{3}\end{matrix} ) & [ Equation 1 ] \\ {LR}_{g} ( L ) = \frac{1}{100} ( \begin{matrix}123.691 - 0.73416064 L + \\ 0.00745865 {L}^{2} - 0.00002496 {L}^{3}\end{matrix} ) & [ Equation 2 ] \\ {LR}_{b} ( L ) = \frac{1}{100} ( \begin{matrix}134.719 - 0.81638272 L + \\ 0.00615039 {L}^{2} - 0.00001468 {L}^{3}\end{matrix} ) & [ Equation 3 ]\end{matrix}$$

In Equation 1 to Equation 3, L denotes a line load ratio, and LRᵣ, LR_{g}, and LR_{b} respectively denote luminance variation ratios of the respective red, green, and blue discharge cells.

When one frame is divided into k subfields and Wₙ denotes a weight of an n^{th} subfield, weights of the plurality of subfields may be given as “W=(W₁, W₂, W₃, . . . , Wₖ)” as vectors. In addition, when aIₙ denotes a light emitting or non-light emitting state of the n^{th} subfield, the light emitting states al of the plurality of subfields may be given as “aI=(aI₁, aI₂, aI₃, . . . , aIₖ)” as vectors. A light-emitting state of the n^{th} subfield is indicated when aIₙ is “1”, and a non-light emitting state of the n^{th} subfield is indicated when aI₁ is “0”. In this case, when assuming that a level of an output grayscale to be expressed is T, the level T of the output grayscale may be expressed as an inner product of the vector W and the vector al as shown in Equation 4.

$$T = aI \cdot W = {\sum }_{n = 1}^{k} {aI}_{n} {W}_{n} \qquad [ Equation 4 ]$$

When the luminance varies according to the line load ratio of the row electrode line, the weight of the subfield also varies. A weight initially allocated to the subfield will be referred to as an “initial set weight”, and the initial set weight varied according to the line load ratio will be referred to as an “output estimation weight”. When L denotes the number of turned on cells, WPₙ denotes an output estimation weight, and WIₙ denotes an initial set weight of the n^{th} subfield, WPn of the red discharge cell may be given as Equation 5.

WPₙ=LRᵣ(LIₙ)×WIₙ [Equation 5]

In Equation 5, LIₙ denotes a line load ratio of the n^{th} subfield. LRᵣ denotes a luminance variation ratio of the red discharge cell. The output estimation weights WP of the plurality of subfields calculated from Equation 5 may be expressed as “WP=(WP₁, WP₂, WP3, . . . , WPₖ)” as vectors. In addition, when the initial set weights WI of the plurality of subfields may be expressed as “WI=(WI₁, WI₂, WI₃, . . . , WIₖ)” as vectors.

Further, when LIₙ denotes a line load ratio of the row electrode line obtained based on the light emitting state a1 of the discharge cells of the row electrode line obtained by using the initial set weight WI in the n^{th} subfield, and G denotes a level of an actual output grayscale of an X^{th} cell, G may be given as Equation 6.

$$G = aI \cdot WP = {\sum }_{n = 1}^{k} {a}_{n} {WP}_{n} \qquad [ Equation 6 ]$$

From Equation 5 and Equation 6, a level error E of the output grayscale is given as Equation 7.

E=G−T =aI·(WP−WI) [Equation 7]

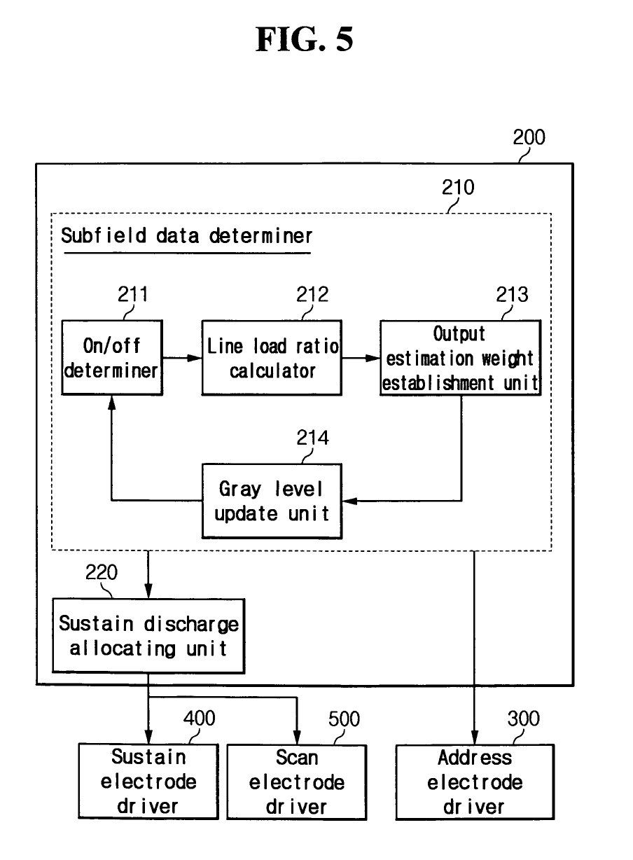

As shown Equation 7, a greater error occurs as a difference between WP and WI increases. A method for improving the error in the output grayscale will now be described with reference to FIG. 5 to FIG. 7.

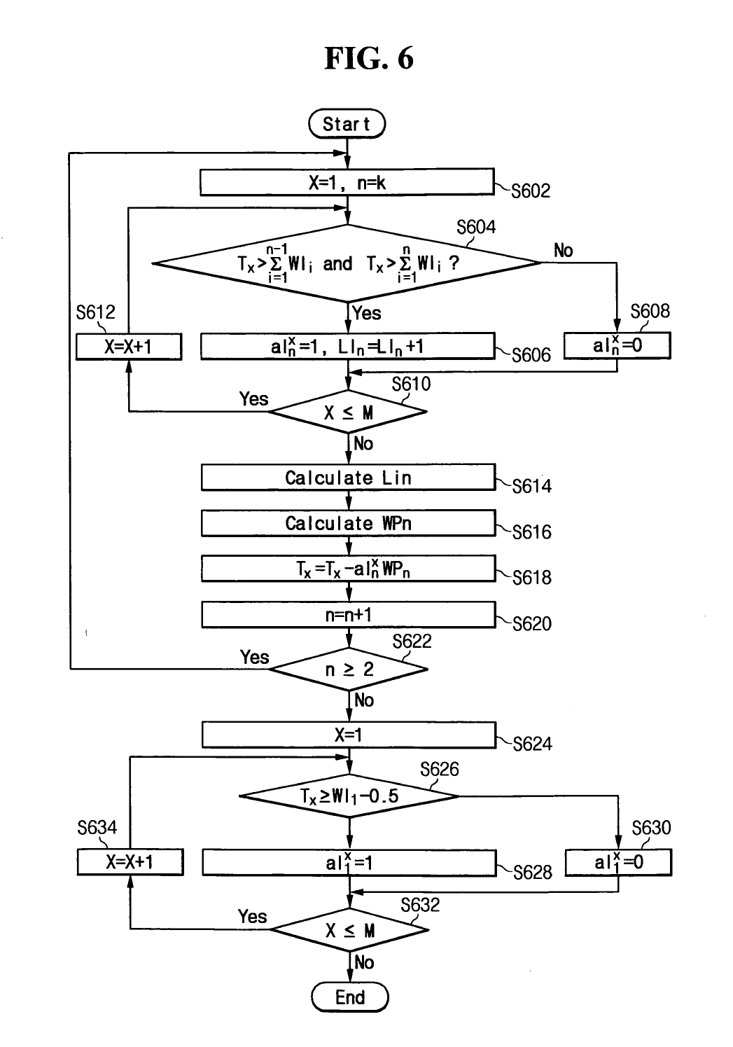

FIG. 5 is a schematic block diagram of the controller 200 according to the exemplary embodiment of the present invention, and FIG. 6 is a flowchart representing a method for compensating the luminance in the controller 200 according to the exemplary embodiment of the present invention.

As shown in FIG. 5, the controller 200 includes a subfield data determiner 210 and a sustain discharge allocating unit 220.

The subfield data determiner 210 determines the light emitting state of each discharge cell of the row electrode line in each subfield in response to the image signal corresponding to each discharge cell of the row electrode line, and generates subfield data according to the determined light emitting state of each subfield. In addition, the subfield data determiner 210 generates a driving signal from the generated subfield data, and applies it to the address electrode driver 300.

The subfield data determiner 210 includes an on/off determiner 211, a line load ratio calculator 212, an output estimation weight establishment unit 213, and a gray level update unit 214.

The on/off determiner 211 determines the light emitting state of each discharge cell of the row electrode line in the plurality of subfields in response to the plurality of image signals corresponding to the respective discharge cells of the row electrode line.

The line load ratio calculator 212 calculates the line load ratio of the row electrode line in the plurality of subfields based on the light emitting state of each discharge cell of the row electrode line.

The output estimation weight establishment unit 213 calculates the output estimation weight of the plurality of subfields based on the line load ratio of the row electrode line in the plurality of subfields.

The gray level update unit 214 updates the input level by using the calculated output estimation weight of the plurality of subfields.

In this case, the on/off determiner 211 uses the initial set weight of the plurality of subfields to determine the light emitting state of each discharge cell of the row electrode line in the subfield having the highest weight among the plurality of subfields, and the line load ratio calculator 212 calculates the line load ratio of the row electrode line based on the light emitting state of each discharge cell of the row electrode line in the subfield having the highest weight. After the output estimation weight establishment unit 213 determines the output estimation weight of the subfield having the highest weight based on the calculated line load ratio, the gray level update unit 214 uses the output estimation weight of the subfield having the highest weight to update a gray level to be expressed by one subfield to (n−1) subfields.

Subsequently, the on/off determiner 211 determines the light emitting state of each discharge cell of the row electrode line in the subfield having the second highest weight among the plurality of subfields by using the initial set weight of the plurality of subfields so as to express the updated gray level, and the line load ratio calculator 212 calculates the line load ratio of the row electrode line based on the determined light emitting state of each discharge cell of the row electrode line in the subfield having the second highest weight. After the output estimation weight establishment unit 213 determines the output estimation weight of the subfield having the second highest weight based on the calculated line load ratio, the gray level update unit 214 uses the output estimation weight of the subfield having the second highest weight value to update the gray level to be expressed by one subfield to (n−2) subfields.

In this way, the on/off determiner 211 determines the light emitting state of the plurality of discharge cells of the row electrode line until the first subfield SF1 by using the initial set weight of each subfield, and generates the subfield data corresponding to the plurality of subfields based on the determined light emitting state of each discharge cell of the row electrode line. Accordingly, since the gray level error caused by the difference between the initial set weight and the output estimation weight in an i^{th} subfield (here, 1i≦n) is applied to the gray level to be expressed by the first to (i−1)^{th} subfields, an error of the output grayscale caused by the line load ratio of the row electrode may be reduced.

The sustain discharge allocating unit 220 allocates the sustain pulses to the respective subfields according to the initial set weights allocated to the plurality of subfields, and transmits the corresponding driving signals to the scan and sustain electrode drivers 400 and 500.

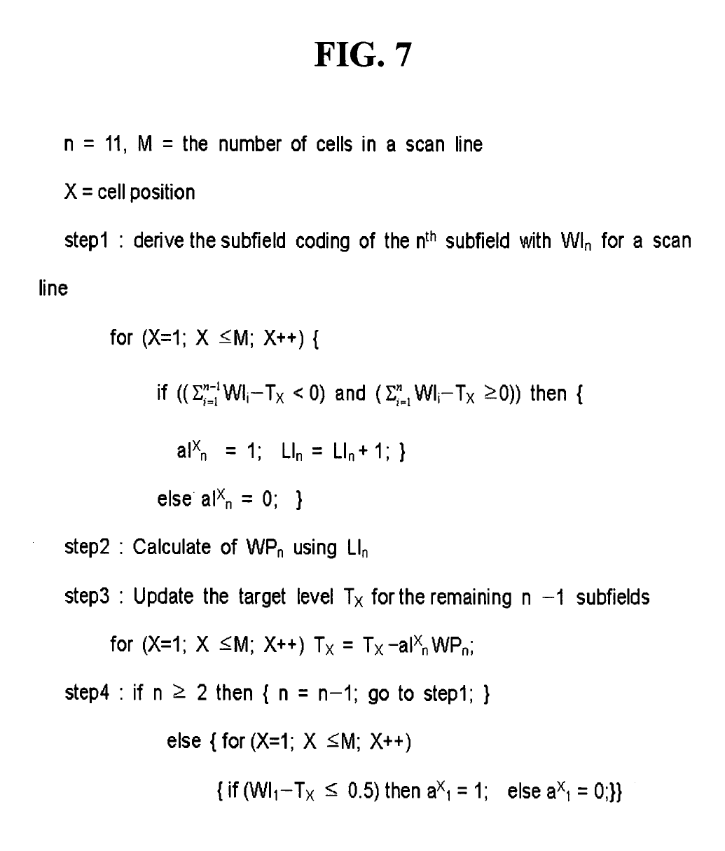

FIG. 6 is a flowchart representing the method for compensating the luminance in the controller 200 according to the exemplary embodiment of the present invention, and FIG. 7 is a diagram representing an algorithm of the method shown in FIG. 6. In FIG. 6, it is assumed that one frame is divided into k subfields and M is the number of discharge cells defined by the row electrode line.

The on/off determiner 211 initializes as X=1 and n=k in step S602. Here, the first to k^{th} subfields are arranged from the subfield having the lowest weight to the subfield having the highest weight. Subsequently, the on/off determiner 211 determines whether the output gray level T_{X} of the image signal corresponding to the X^{th} discharge cell among M discharge cells of the row electrode line satisfies a condition of

$$( {\sum }_{i = 1}^{n - 1} {WI}_{i} - {T}_{X} < 0 ) and ( {\sum }_{i = 1}^{n} {WI}_{i} - {T}_{X} \geq 0 ) .$$

When T_{X} satisfies the condition, since T_{X} cannot be obtained by one subfield to (n−1) subfields, the on/off determiner 211 turns on an n^{th} subfield SFn. That is, aI^{X}ₙ is set to be “1” in step S606. In this case, when aI^{X}ₙ is set to be “1”, the line load ratio calculator 212 increases LIₙ (i.e., the number of turned on cells among the discharge cells of the row electrode line in the n^{th} subfield) by 1.

When T_{X} does not satisfy the condition of

$$( {\sum }_{i = 1}^{n - 1} {WI}_{i} - {T}_{X} < 0 ) and ( {\sum }_{i = 1}^{n} {WI}_{i} - {T}_{X} \geq 0 ) ,$$

since T_{X} can be obtained by one subfield to (n−1) subfields, the on/off determiner 211 does not turn off the n^{th} subfield. That is, aI^{X}ₙ is set to be “0” in step S608. In addition, the on/off determiner 211 compares X and M to update X as “X=X+1” in steps S610 and S612.

Subsequently, by repeatedly performing the steps S606 to S612, the on/off determiner 211 determines the light emitting state of the first to M^{th} discharge cells in the n^{th} subfield.

As described, when the on/off determiner 211 determines the light emitting states of the respective discharge cells of the row electrode line in the n^{th} subfield, the line load ratio calculator 212 calculates the line load ratio LIₙ of the row electrode line from the determined light emitting states in step S614. The output estimation weight establishment unit 213 calculates the output estimation weight WPₙ of the n^{th} subfield based on the line load ratio LIₙ in step S616.

Subsequently, in the cell in which the n^{th} subfield is turned on, by using the output estimation weight WPₙ of the n^{th} subfield, the output gray level T_{X} to be realized by using the first to (n−1)^{th} subfields is updated to be (T_{X}−al^{X}ₙWPₙ) in step S618, and n is updated to be (n−1) in step S620. In this case, the on/off determiner 211 determines in step S622 whether n is equal to or greater than 2, and repeatedly performs the steps S602 to S622 until n becomes less than 2.

Thereby, the light emitting states of the plurality of discharge cells of the row electrode line from the second to k^{th} subfields SF2 to SFk are determined.

In the first subfield (n=1), the on/off determiner 211 initializes X to be 1 in step S624, and determines in step S626 whether T_{X} of the X^{th} discharge cell (X=1) satisfies a condition of WI₁−T_{X}≦0.5. When T_{X} satisfies the condition, the on/off determiner 211 establishes aI^{X}₁ to be 1 in step S628. When T_{X} does not satisfy the condition of WI₁−T_{X}≦0.5, the on/off determiner 211 establishes aI^{X}₁ to be 0 in step S630.

Subsequently, the on/off determiner 211 determines in step S628 whether X is less than M, and repeatedly performs the steps S626 to S628 until X becomes less than M to determine the light emitting state of the first to M^{th} discharge cells in the first subfield.

As described, since the light emitting states of the plurality of subfields SF1 to SFk in the respective discharge cells are determined when the light emitting state of the first subfield (N=1) is determined, the corresponding subfield data are generated, which is expressed by the algorithm shown in FIG. 7.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiment of the present invention, a predetermined luminance may be maintained for the same grayscale regardless of the line load ratio since the luminance may not be varied according to the line load ratio.

What is claimed is:

1. A method for driving a plasma display comprising a row electrode, a plurality of column electrodes, and a plurality of discharge cells defined by the row electrode and the plurality of column electrodes, the method comprising:
dividing one frame into a plurality of subfields respectively having initial set weights;
determining a light emitting state of the plurality of discharge cells of the row electrode by a gray level of image data input during one frame using the initial set weight in a first subfield among the plurality of subfields;
calculating a line load ratio of the row electrode based on the light emitting state of the plurality of discharge cells of the row electrode in the first subfield;
calculating an output estimation weight of the first subfield based on the line load ratio of the row electrode in the first subfield;
updating the gray level according to the output estimation weight of the first subfield in the first subfield;
determining the light emitting state of the plurality of discharge cells of the row electrode by the updated gray level using the initial set weight in a second subfield among the plurality of subfields;
calculating the line load ratio of the row electrode based on the light emitting state of the plurality of discharge cells of the row electrode in the second subfield;
calculating the output estimation weight of the second subfield based on the line load ratio of the row electrode in the second subfield; and
updating the updated gray level according to the output estimation weight of the second subfield.

2. The method of claim 1, wherein the output estimation weight of the first subfield is calculated by the line load ratio, the initial set weight of the first subfield, and a luminance variation ratio of the discharge cell having a corresponding color.

3. The method of claim 2, wherein the initial set weight of the second subfield is less than the initial set weight of the first subfield.

4. The method of claim 1, further comprising:
determining the light emitting state of the plurality of discharge cells of the row electrode by the gray level updated based on the output estimation weight of the second subfield in a third subfield among the plurality of subfields;
updating the line load ratio of the row electrode based on the light emitting state of the plurality of discharge cells of the row electrode in the third subfield;
calculating the output estimation weight of the third subfield based on the line load ratio of the row electrode; and
updating the gray level updated according to the output estimation weight of the second subfield, based on the output estimation weight of the third subfield,
wherein the initial set weights of the subfields are reduced in an order of the first subfield, the second subfield, and the third subfield.

5. A method for driving a plasma display comprising a row electrode, a plurality of column electrodes, and a plurality of discharge cells defined by the row electrode and the plurality of column electrodes, the method comprising:
dividing one frame into a plurality of subfields respectively having initial set weights;
establishing n to be i (here, n is a positive integer, and i≦n);
determining a light emitting state of the plurality of discharge cells of the row electrode in an n^{th} subfield based on a gray level of input image data and the initial set weight;
calculating a line load ratio of the row electrode based on the determined light emitting state in the n^{th} subfield;
calculating an output estimation weight of the n^{th} subfield based on the line load ratio of the row electrode;
updating a gray level based on the output estimation weight of the n^{th} subfield;
establishing n to be j that is different from i; and
repeatedly performing the determining of the light emitting state, the calculating of the line load ratio, the calculating of the output estimation weight, and the updating of the gray level.

6. The method of claim 5, wherein i is a number corresponding to the subfield having the highest weight among the plurality of subfields.

7. The method of claim 6, wherein the plurality of subfields are arranged in an order of the weight sizes, and the establishing of n to be j that is different from i comprises establishing j to be i−1.

8. The method of claim 7, wherein the repeatedly performing is repeatedly performed until n is greater than 1, and further comprises determining the light emitting state of the plurality of discharge cells of the row electrode when n is 1, and outputting a driving signal to the row electrode and the column electrode according to the light emitting state of the plurality of subfields for the respective discharge cells.

9. The method of claim 6, wherein the output estimation weight of the n^{th} subfield is obtained based on the line load ratio of the row electrode and the initial set weight of the n^{th} subfield.

10. A plasma display comprising:
a row electrode in which a plurality of discharge cells are formed;
a controller for dividing one frame into a plurality of subfields respectively having initial set weights, updating a gray level of image data according to an output estimation weight of an i^{th} subfield of the plurality of subfields, and determining a light emitting state of the plurality of discharge cells according to the updated gray level by using the initial set weight of the plurality of subfields in an (i−1)^{th} subfield; and
a driver for discharging the plurality of discharge cells according to the light emitting state of the plurality of discharge cells in the plurality of subfields,
wherein the light emitting state of the plurality of discharge cells in an (i+1)^{th} subfield is determined based on the gray level, and the output estimation weight of the i^{th} subfield is determined based on the initial set weight of the plurality of subfields and the determined light emitting state in the (i+1)^{th} subfield.

11. The plasma display of claim 10, wherein the output estimation weight of the i^{th} subfield is obtained based on the line load ratio calculated based on the light emitting state of the plurality of discharge cells in the i^{th} subfield and the initial set weight of the i^{th} subfield.

12. The plasma display of claim 10, wherein first to last subfields are arranged from the subfield having the lowest initial set weight to the subfield having the highest initial set weight, and when the number of subfields is n, the controller repeatedly performs operations for updating the gray level and determining the light emitting state until i reaches to 2 from (n−1).

13. A plasma display having a row electrode in which a plurality of discharge cells are formed, comprising:
a controller for dividing one frame into a plurality of subfields in which each subfield of said plurality of subfields has an initial set weight, updating a gray level of image data according to an output estimation weight of a subfield of the plurality of subfields, and determining a light emitting state of the plurality of discharge cells according to the updated gray level by using the initial set weight of a previous subfield of the plurality of subfields; and
a driver for discharging the plurality of discharge cells according to the light emitting state of the plurality of discharge cells in the plurality of subfields,
wherein the light emitting state of the plurality of discharge cells in a subsequent subfield is determined based on the gray level, and the output estimation weight of the subfield is determined based on the initial set weight of the plurality of subfields and the determined light emitting state in the subsequent subfield.

14. The plasma display of claim 13, wherein the output estimation weight of the subfield is obtained based on the line load ratio calculated based on the light emitting state of the plurality of discharge cells in the subfield and the initial set weight of the subfield.

15. The plasma display of claim 13, wherein an order of subfields is arranged from the plurality of subfields starting with a subfield having a lowest initial set weight to the subfield having the highest initial set weight, and the controller repeatedly performs operations for updating the gray level and determining the light emitting state.
